(19) United States
(12) Patent Application Publication
(10) Pub. No.: US 2006/0116615 A1
(43) Pub. Date: Jun. 1, 2006

(54) Driving device for external counterpulsation

(75) Inventors: Zhensheng Zheng, Guangzhou (CN); Jinfang Yang, Guangzhou (CN); Kuijian Wang, Guangzhou (CN); Zhimin Du, Guangzhou (CN)

Correspondence Address: SCHULTE ROTH & ZABEL LLP;ATTN: JOEL E. LUTZKER, 919 THIRD AVENUE, NEW YORK, NY, 10022, US

(73) Assignee: BIOMEDICAL ENGINEERING DEVELOPMENT CENT, SUN YATSEN UNIVERSITY OF MEDICAL SCIENCES, GUANGZHOU (CN)

(21) Appl. No.: 10/542,690

(22) PCT Filed: Jun. 4, 2004
(86) PCT No.: PCT/CN04/00606

§ 371 Date: Jul. 19, 2005

(30) Foreign Application Priority Data
Jul. 25, 2003 (CN) 03139939.8

(51) Int. Cl. A61H 7/00

(52) U.S. Cl. 601/84

(57) ABSTRACT

An external counter-pulsation device in accordance with the present invention includes a solenoid valve (1) and a cylinder (2). A gas-supplying pipe (4) is connected between the solenoid valve (1) and the cylinder (2), for supplying gas to the cylinder (2). A piston (21) is positioned inside the cylinder (2). The piston (21) is connected with a pushing board (3) via a pushing pole (22). A soft medium layer (6) is secured on the inside surface of the pushing board (3), for preventing the body (5) of a patient from being injured. The cylinder (2) is secured to a holding board (8). Two ends of a surrounding strip (7) are fastened to the holding board (8), for confining the body (5). The cylinder applies gas with high pressure, so the gas consumption can be reduced and the external counter-pulsation device of the present invention has improved treatment results.

### BACKGROUND OF THE INVENTION

1. Field of the Invention

The present invention relates to a medical device, and more particularly to external counter-pulsation device which can increase blood flow.

2. Description of the Prior Art

External counter-pulsation is a mean of treating the cardio-cerebrovascular diseases, which is invented in recently twenty years. These means are performed by rhythmically press the body of a patient, with matching to the pulsation of heart, so as to increase blood flow.

In conventional external counter-pulsation devices, the driving device usually applies an gas sac of low pressure adapted to charge and discharge gas. Because of low pressure (0.25˜0.40 kg/cm²) driving, the external counter-pulsation device must apply a pump of large volume. The connecting pipe of the external counter-pulsation is also large. Furthermore, because of the pressure of gas source is low, the gas sac can't be charged or discharged quickly, so that treatment results are not good. Moreover, discharging gas slowly would cause that gas in the gas sac could not be discharged totally. Residual gas in the gas sac would make patients feel discomfortable.

Therefore, it is desired to provide an external counter-pulsation device which has a small volume and can be charged and discharged quickly.

### SUMMARY OF THE INVENTION

Accordingly, an object of the present invention is to provide an external counter-pulsation device which has a small volume and can provide an improved treatment results.

To achieve the above object, the external counter-pulsation device in accordance with the present comprises:
a solenoid valve;
a cylinder comprising a piston positioned therein; a gas-supplying pipe being connected between the solenoid valve
and the cylinder, for supplying gas to the cylinder;
a pushing board being connected with the piston of the cylinder by
a pushing pole;
a holding board, the cylinder being secured on the holding board; and
a surrounding strip secured to the holding board.

The external counter-pulsation device in accordance with the present can also comprise:
a solenoid valve;
a cylinder comprising a piston positioned therein;
a pushing pole being connected with the piston of the cylinder;
a gas-supplying pipe being connected between the solenoid valve
and the cylinder, for supplying gas to the cylinder;
a pushing board for pressing the body of a patient;
a surrounding strip, for confining the body; and
a pulling element being connected between the pushing pole and the surrounding strip.

Other objects, advantages and novel features of the present invention will become more apparent from the following detailed descriptions when taken in conjunction with the accompanying drawings, in which:

### BRIEF DESCRIPTION OF THE DRAWINGS

FIG. 1 is a schematic view of the external counter-pulsation device in accordance with the present invention;

FIG. 2 is an exploded view of the external counter-pulsation device in accordance with the present invention;

FIG. 3A is a schematic view of the secondary embodiment of the present invention;

FIG. 3B is a schematic view of the third embodiment of the present invention; and

FIG. 4 is a schematic view of the external counter-pulsation device in accordance with the present invention, wherein a patient is being treating.

### DETAILED DESCRIPTION OF THE INVENTION

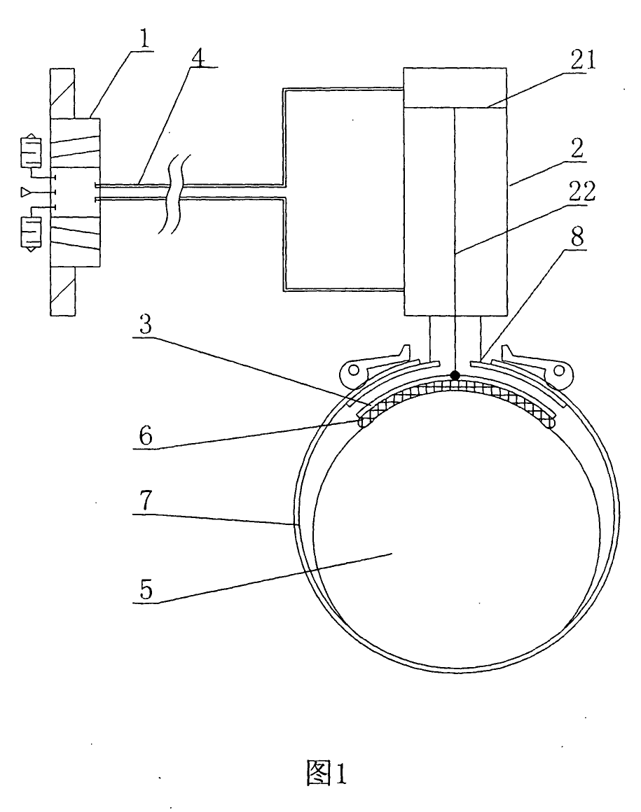

Referring to FIG. 1, the external counter-pulsation device in accordance with the preferred embodiment of the present invention comprises a solenoid valve 1 and a cylinder 2. A gas-supplying pipe 4 is connected between the solenoid valve 1 and the cylinder 2, for supplying gas to the cylinder 2. A piston 21 is positioned inside the cylinder 2. The piston 21 is connected with a pushing board 3 via a pushing pole 22. A soft medium layer 6 is secured on the inside surface of the pushing board 3, for preventing the body 5 of a patient from being injured. The cylinder 2 is secured to a holding board 8. Two ends of a surrounding strip 7 are fastened to the holding board 8, for confining the body 5. In using, when the solenoid valve 1 receives controlling signals from the central processing unit (CPU) of the external counter-pulsation device, the gas-supplying pipe 4 starts to supply gas from peripheral gas pump and gas storage tank to the cylinder 2. After the cylinder 2 is charged gas, the piston 21 move downwards, thereby driving the pushing board 3 to press evenly the body 5. Being confined by the surrounding strip 7, the body 5 cannot expand so that the blood inside the body 5 is effectively pressed to flow upwards and blood flow increases.

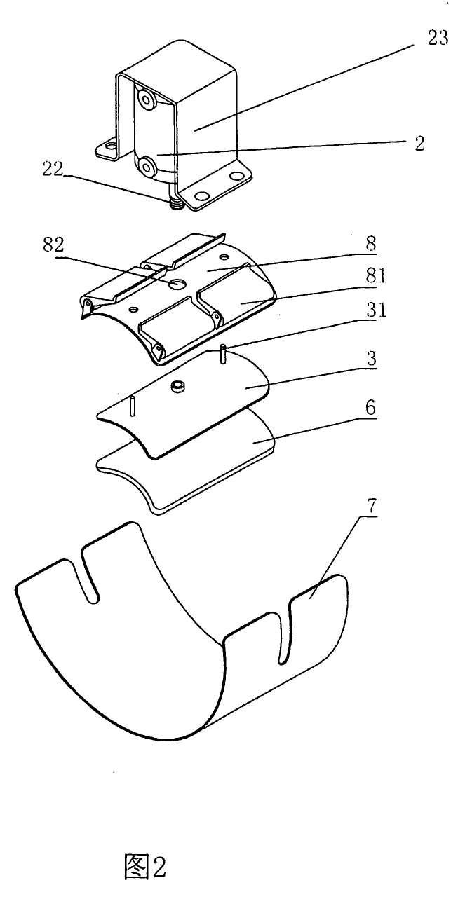

Referring to FIG. 2, a holding racket 23 is positioned outside the cylinder 2, for securing the cylinder 2 to the holding board 8. The holding board 8 has peripheral holding nips 81 adapted to engage with the surrounding strip 7. The pushing pole 22 can pass through the central hole 82 of the holding board 8 to connect with the pushing board 3. The pushing board 3 has guiding poles 31 thereon adapted to pass through the corresponding pores (not labeled) of the holding board 8. The guiding poles 31 have enough length and can ensure that the pushing board 3 moves repeatedly in the predetermining direction.

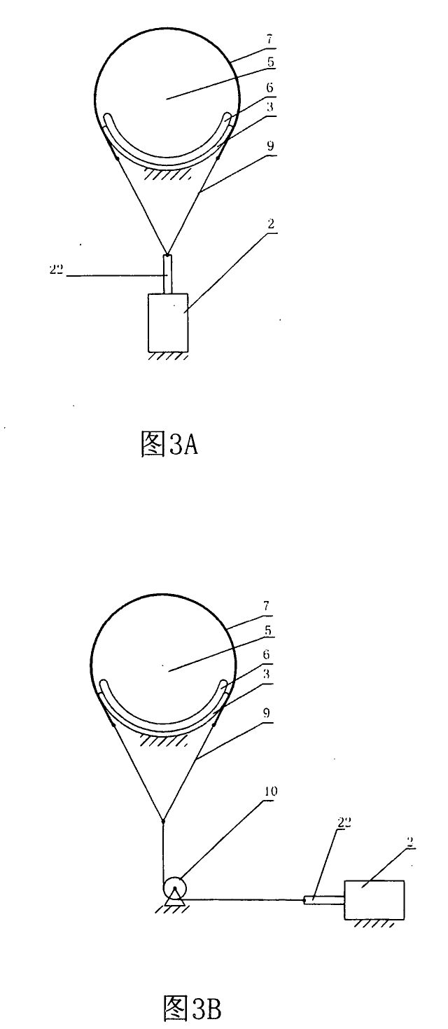

Referring to FIG. 3A, the secondary embodiment of the present invention is shown. The cylinder 2 is positioned below the body 5. A pulling element 9 is connected between the pushing pole 22 and the surrounding strip 7. When the pushing pole 22 moves downwards, the pulling element 9 pulls the surrounding strip 7 to press the body 5. The soft medium layer 6 on the pushing board 3 exerts a pressure to the body 5, and press the blood flow upwards.

Referring to FIG. 3B, the third embodiment of the present invention is shown. The cylinder 2 is positioned beside the body 5. A wheel 10 is positioned between the pulling element 9 and the pushing pole 22, for changing the pulling direction of the cylinder 2.

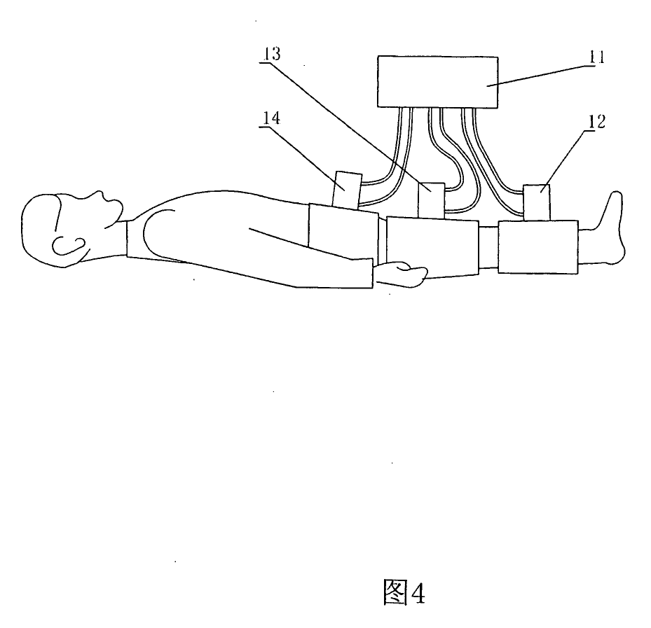

One solenoid valve can control one or one pair of cylinders. In clinical use, the external counter-pulsation device in accordance with the present invention can apply a solenoid valve assembly that comprises a plurality of solenoid valves. Referring to FIG. 4, a patient lies down on a bed, the external counter-pulsation device of the present invention is positioned above the patient. The solenoid valve assembly 11 is connected with the cylinders 12, 13, 14 via the gas-supplying pipes. The cylinders 12, 13, 14 can be positioned above, below or beside the patient in accordance with different situation.

The volume of the cylinder is designed according to the pressure of air source. The pressure exerted on the body by the pushing board must meet the requirement of external counter-pulsation, that is 0.25˜0.4 kg/cm².

The pushing board 3 can be made of hard and elastic material, for example, metal, plastic, bamboo material, wood material and so on. The size of the pushing board 3 is designed according to the pressed body. For example, the pushing board 3 for crus is 10-20 cm width, and for thigh 12-30 cm width, for upper limbs 4-10 cm, for buttocks 35-60 cm. The length of the pushing board 3 is the same as the pressed range of the body.

The soft medium layer 6 can be selected from water sac, oil sac, silica gel, plasticene, soft plastic material, artificial fiber, viscose fiber, medical cotton, sand bag or other soft materials.

The work pressure of the cylinder of the present invention is 3-7 kg/cm², the inside diameter of the cylinder is 40 cm or 50 cm, so the gas consumption is reduced and the diameter of the gas-supplying pipe is decreased from 15-20 mm to 6 mm, so that the external counter-pulsation device in accordance with the present invention become smaller and lighter. It is more import that the charging and discharging speed of the cylinder is faster than that of the gas sac, whereby the external counter-pulsation device in accordance with the present invention has improved treatment results.

In the external counter-pulsation device of the present invention, the cylinder applies high pressure gas, so the gas consumption is reduced, and the solenoid valve and the gas-supplying pipe is also decreased, so that the external counter-pulsation device of the present invention become smaller and lighter. The external counter-pulsation device of the present invention can be used not only in salvage but also in exercise, health care and so on.

It is understood that the present invention may be embodied in other forms without departing from the spirit thereof. Thus, the present examples and embodiments are to be considered in all respects as illustrative and not restrictive, and the invention is not to be limited to details given herein.

What is claimed is:

1. An external counter-pulsation device comprising:
a solenoid valve;
a cylinder comprising a piston positioned therein;
a gas-supplying pipe being connected between the solenoid valve and the cylinder, for supplying gas to the cylinder;
a pushing board being connected with the piston of the cylinder by a pushing pole;
a holding board, the cylinder being secured on the holding board; and
a surrounding strip secured to the holding board.

2. The external counter-pulsation device in accordance with claim 1, further comprising a holding racket secured on the holding board, the cylinder being positioned inside the holding racket.

3. The external counter-pulsation device in accordance with claim 1, further comprising a soft medium layer on the pushing board.

4. The external counter-pulsation device in accordance with claim 1, wherein the soft medium layer is selected from water sac, oil sac, silica gel, plasticene, soft plastic material, artificial fiber, viscose fiber, medical cotton or sand bag.

5. The external counter-pulsation device in accordance with claim 1, wherein the holding board has peripheral holding nips that engage with two ends of the surrounding strip.

6. The external counter-pulsation device in accordance with claims 1 or 4, wherein the holding board has a central hole and the pushing pole passes through the central hole to connect with the pushing board.

7. The external counter-pulsation device in accordance with claim 1, wherein the pushing board has guiding poles thereon which pass through corresponding pores of the holding board.

8. An external counter-pulsation device comprising:
a solenoid valve;
a cylinder comprising a piston positioned therein;
a pushing pole being connected with the piston of the cylinder;
a gas-supplying pipe being connected between the solenoid valve and the cylinder, for supplying gas to the cylinder;
a pushing board for pressing the body of a patient;
a surrounding strip, for confining the body; and
a pulling element being connected between the pushing pole and the surrounding strip.

9. The external counter-pulsation device in accordance with claim 8, further comprising a wheel positioned between the pulling element and the pushing pole, for changing the pulling direction of the cylinder.

10. The external counter-pulsation device in accordance with claims 1 or 8, wherein the pressure exerted by the pushing board must meet the requirement of external counter-pulsation, that is 0.25˜0.4 kg/cm².

11. The external counter-pulsation device in accordance with claims 1 or 8, wherein the pushing board is made of hard and elastic material.

12. The external counter-pulsation device in accordance with claim 11, wherein the pushing board is made of metal, plastic, bamboo material or wood material.
